(19) United States
(12) Patent Application Publication
(10) Pub. No.: US 2005/0227201 A1
(43) Pub. Date: Oct. 13, 2005

(54) Irrigation tip adaptor for ultrasonic handpiece

(76) Inventor: Gary J. Pond, Racine, WI (US)

Correspondence Address: RYAN KROMHOLZ & MANION, S.C., POST OFFICE BOX 26618, MILWAUKEE, WI, 53226, US

(21) Appl. No.: 10/820,931

(22) Filed: Apr. 8, 2004

(51) Int. Cl. A61C 3/03

(52) U.S. Cl. 433/119

(57) ABSTRACT

An adaptor for coupling a dental irrigation tip to an ultrasonic dental handpiece is disclosed. The dental handpiece is connected to a fluid source. The adaptor comprises an elongated body having a distal end for connection to the irrigation tip and a proximal end for connection to the dental handpiece. The elongated body has a through bore in fluid communication with the dental handpiece and the irrigation tip. In an alternate embodiment, the adaptor may replace the ultrascaling dental handpiece.

### BACKGROUND OF THE INVENTION

The present invention relates to dental equipment and, more specifically, to ultrasonic dental scalers used for cleaning and treating a person's teeth. Ultrasonic scalers generally have a handpiece connected to a power supply. The handpiece is connected directly to a tip or connected to a sleeve that houses a tip, which is used in the person's mouth during a dental procedure. The power supply establishes an electrical current through the handpiece and/or sleeve to the tip, which allows dentist or hygienist to clean a person's teeth with the ultrasonic energy transferred to the tip of the device.

Hygiene is a very important aspect in dental procedures. Consequently, most dental attachments are designed so that they are autoclavable, which allows the attachments to be easily removed and cleaned. Generally, most dental attachments are used only once before they are removed from a dental device and cleaned. For instance, an ultrasonic scaler tip will be removed after being used on a single patient and autoclaved for future uses.

Because of the energy exerted by the ultrasonic scaler to the tip and the heat associated therewith, water is necessary to cool down the tip and the work area while the scaler is being used. Advancements, such as Hickock, U.S. Appl. No. 2002/0072035, have been made to provide a water flow to the tip of the ultrasonic scaler. However, the water flow is in conjunction with the use of the scaler tip. The disclosed Hickock device and similar devices do not provide an alternative to use the ultrasonic scaler handpiece solely as an irrigation device.

Besides using water to cool down the scaler, water or another rinsing fluid is commonly used in conjunction with an ultrasonic scaler to irrigate the mouth or teeth separately during the dental procedure. Generally a second handpiece directly connected to a water reservoir is kept near the scaler so the water can be applied when necessary to rinse the mouth and remove debris from the scaling process. Thus, when irrigation is necessary, a separate irrigation handpiece is used. An example of the second handpiece is an air-water syringe commonly found in a dental operation.

The prior art has attempted to simplify devices that contain separate irrigation and scaler devices. For instance, Descoter et al., U.S. Appl. No. 2003/0077552, describes a dental apparatus where the scaler and the irrigator receive power and fluid from the same source. However, the invention still has two separate hand-held devices, one containing the ultrasonic scaling tip and second containing an irrigation tip. The present invention improves upon the prior art by providing a device allowing the ultrasonic scaler handpiece to be utilized as an irrigation device without affecting the utility of the ultrasonic scaler.

### SUMMARY OF THE INVENTION

The present invention provides an adaptor for use with an ultrasonic scaler, specifically an ultrasonic scaler handpiece. The adaptor allows for the connection of an irrigation tip to the ultrasonic scaler. The adaptor provides means to use the scaler handpiece as an irrigation device, without ultrasonic energy being transferred to the irrigation tip from the ultrasonic handpiece. In an alternative embodiment, the adaptor may be designed to replace the ultrasonic handpiece and connect directly to the base section of the ultrasonic device.

### BRIEF DESCRIPTION OF THE DRAWINGS

FIG. 1 depicts a diagrammatic view of an ultrasonic scaler device according to the prior art.

FIG. 2 depicts a diagrammatic view of an ultrasonic dental apparatus in accordance with the present invention.

FIG. 3 is a perspective view of an ultrasonic scaler handpiece assembly in accordance with the present invention.

FIG. 4 is an exploded view of the ultrasonic scaler handpiece assembly depicted in FIG. 3.

FIG. 5 is a close-up partial view of the ultrasonic scaler handpiece.

FIG. 6 is a rear perspective view of the ultrasonic scaler handpiece.

FIGS. 7-11 depict embodiments of adaptor assemblies in accordance with the present invention.

FIGS. 12-14 depict further embodiments of an adaptor assembly in accordance with the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structure. While the preferred embodiment has been described, the details may be changed without departing from the invention, which is defined by the claims.

FIG. 1 portrays a diagrammatic illustration of a known combination ultrasonic scaler and irrigator apparatus 10. The apparatus 10 has a base unit 12, which represents the housing for the apparatus 10. The base unit 12 is connected to a water supply 13 and a power source 15. The base unit 12 is also connected to a water line 14, which is in turn connected to water lines 16 and 18. The water lines 16 and 18 are connected to a dedicated irrigation handpiece 20 and an ultrasonic scaler handpiece 22, respectively. Directional flow means 24, which may be a check valve or other similar device or arrangement, allows water to flow to either the scaler handpiece 22 or the irrigation handpiece 20. An electrical connection exists between base unit 12 and scaler handpiece 22 through conduits 14 and 18 for supplying electrical energy to the ultrasonic scaler. A control apparatus, such as a foot pedal 17, is also connected to the base unit 12 to regulate the amount of energy delivered to the ultrasonic scaler. The device is designed to simplify the arrangement and connection of the water supply for the apparatus 10, but still requires two separate handpieces for irrigation and scaling.

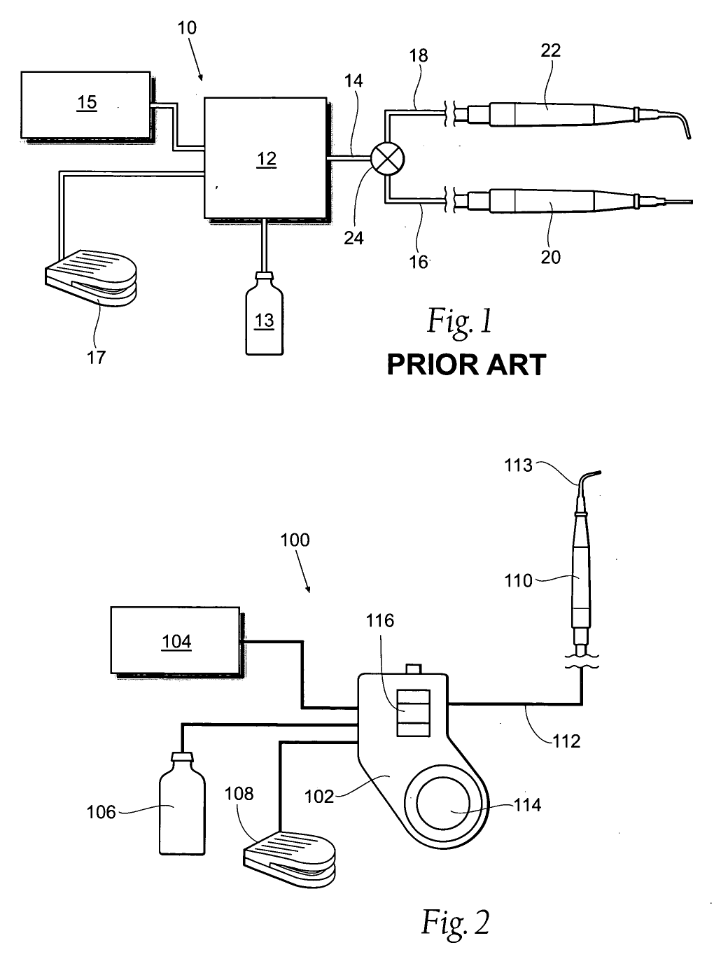

FIG. 2 depicts a diagrammatic view of an ultrasonic dental device 100 that could utilize the present invention. The dental device 100 comprises a housing unit 102 that contains and is connected to various equipment and apparatuses. As shown, the housing unit 102 receives inputs from a power supply 104, a water or other fluid reservoir (or source) 106, and a control pedal 108. It should be understood that these devices are merely exemplary of attachments for the dental device 100. For instance there may be more than one fluid reservoir 106, possibly to hold water and a separate fluid, such as medicament. Likewise, the control pedal 108 should be considered broadly to encompass any arrangement that would provide control means for the dental device 100.

Still referring to FIG. 2, the housing 102 is connected to the scaling instrument 110 by a supply line or conduit 112. The supply line 112 generally represents separate lines that may be in communication with the scaling instrument 110, such as power lines and fluid lines. The scaling instrument 110 will operate similarly as other devices known in the art. A scaling tip 113 is attached to the scaling instrument 110 at its distal end. The scaling tip 113 preferably will not be used concurrently when the present invention is being utilized, but will be replaced with an irrigation tip. The housing unit 102 may contain a clip or other holding device 116 to secure the scaling instrument 110 when not in use. For operation of the scaling instrument 110, the control pedal 108 and a control panel 114 located on the housing unit 102 provide means for directing power and fluid flow to the scaling instrument 110. In a preferred embodiment, the control panel 114 controls the amount of power (i.e. intensity) delivered to the scaling instrument 110. The foot pedal 108 acts as an on-off switch for power and fluid flow to the instrument or handpiece 110. The present invention may be utilized in a wide arrangement of devices 100 and does not necessitate the need for separate power and fluid controls. That is, if the foot pedal 108 in the ultrasonic dental device 100 controls both the fluid and power flow, the present invention can be used with the dental device. Similarly, if the foot pedal 108 only controlled only one the fluid or power flows, the present invention could also be utilized.

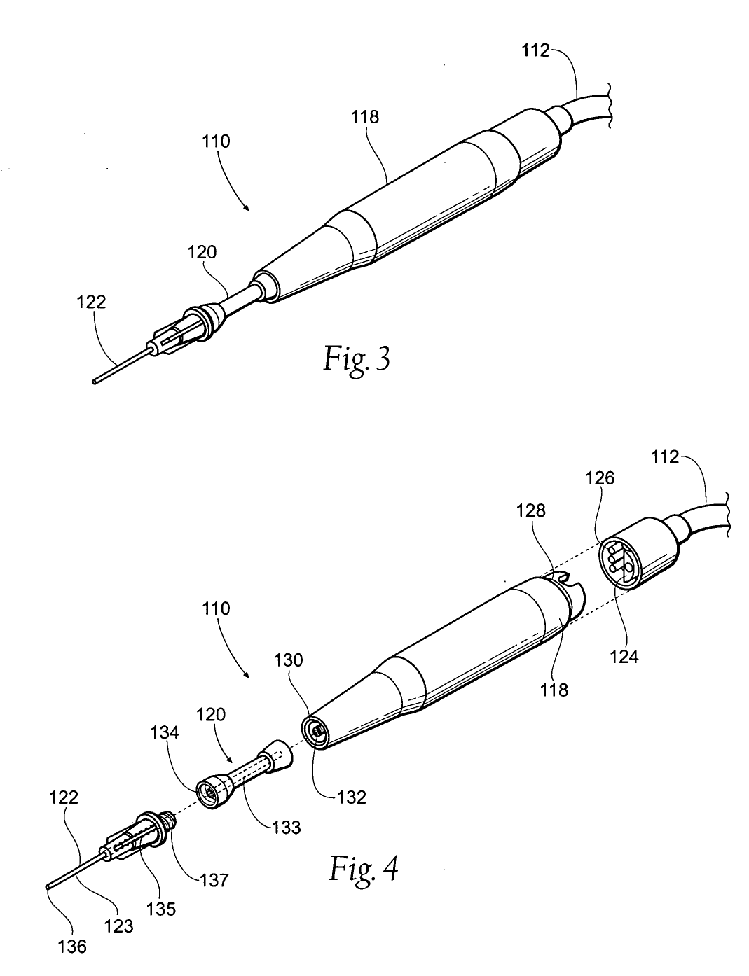

FIG. 3 provides a perspective view of the scaling instrument 110 utilizing the present invention. The scaling instrument 110 includes a handpiece 118, an adaptor 120, and an irrigation tip 122. Ultrasonic vibration means (not shown), such as an ultrasonic transducer that is known in the art, are located within the handpiece 118. The ultrasonic vibration means receives power through the supply line 112 so that the instrument 110 may potentially act as an ultrasonic scaling device, as described with respect to FIG. 2. However, the adaptor 120 provides means for eliminating the flow of ultrasonic energy beyond the handpiece 118, while providing a coupling for receiving the irrigation tip 122, instead of the scaling tip 113 (see FIG. 2). In a preferred embodiment, the tip 122 is a disposable tip. Thus, as arranged in FIG. 3, the instrument 110 will act solely as an irrigation device and will not transmit ultrasonic energy to the tip 122. Fluid will be delivered through the supply line 112, the handpiece 118, and the adaptor 120 to the tip 122 without ultrasonic energy, even though the handpiece 118 is configured for delivering ultrasonic energy.

FIG. 4 depicts an exploded view of the scaling instrument 110. As previously noted, the supply line 112 may contain several different feed lines for the scaling instrument 110. For instance, connections for a fluid line 124 and power lines 126 are depicted within the supply line 112. The fluid line 124 and the power line 126 will mate to a proximal end 128 of the handpiece 118 (see FIG. 6). The fluid line 124 will pass through a conduit (not shown) within the handpiece 118 and will exit from a distal end 130 of the handpiece 118 through a fluid outlet 132. The power lines 126 provide energy to the ultrasonic scaling means (not shown) so that the instrument may act as an ultrasonic scaling device. However, as noted, the adaptor 120 will mate with the distal end 130 and the outlet 132 in such a manner that fluid will pass through the adaptor 120, but ultrasonic energy will not be transferred through the adaptor 120. The adaptor 120 is further designed in such a manner or from a material that will prevent transferred energy, most specifically in the form of heat, from physically deteriorating the adaptor 120 when the adaptor 120 comes into contact with the ultrasonic scaling means. This is an important feature because the heat emitted from ultrasonic scaling means can be quite high.

Still referring to FIG. 4, a through bore 133 (shown in phantom) located in the adaptor 120 will securely mate with the outlet 132, forming a fluid-tight connection, and fluid will continue through the through bore 133 (shown in phantom) in the adaptor 120 and exit at a portal 134. The portal 134 mates with the irrigation tip 122 so that fluid will pass through a second through bore 135 within the tip 122 and exit at the end 136 of the tip 122. In a preferred embodiment, the adaptor 120 will be connected to the tip 122 by use of a conventional LUER-LOK® connection arrangement 137. However, other connecting means 137 for the tip 122 and the adaptor 120 are possible, and the adaptor 120 and the tip 122 may be designed as a single, integral attachment. Provided a fluid pathway is maintained, the connection means 137 would fall within the scope of the present invention. The connecting means 137 will allow the tip 122 to mate with the adaptor 120 to maintain fluid flow between the portal 134 and the second through bore 135 located within the irrigation tip 122. Irrigation tip 122 further includes a lumen section 123 that may be flexible or rigid. For example, the lumen section 123 may be formed from a stiff plastic material or, alternatively, may be formed from a metal that is either rigid or malleable. For purposes of example only, the lumen 123 may be formed from stainless steel or nickel titanium.

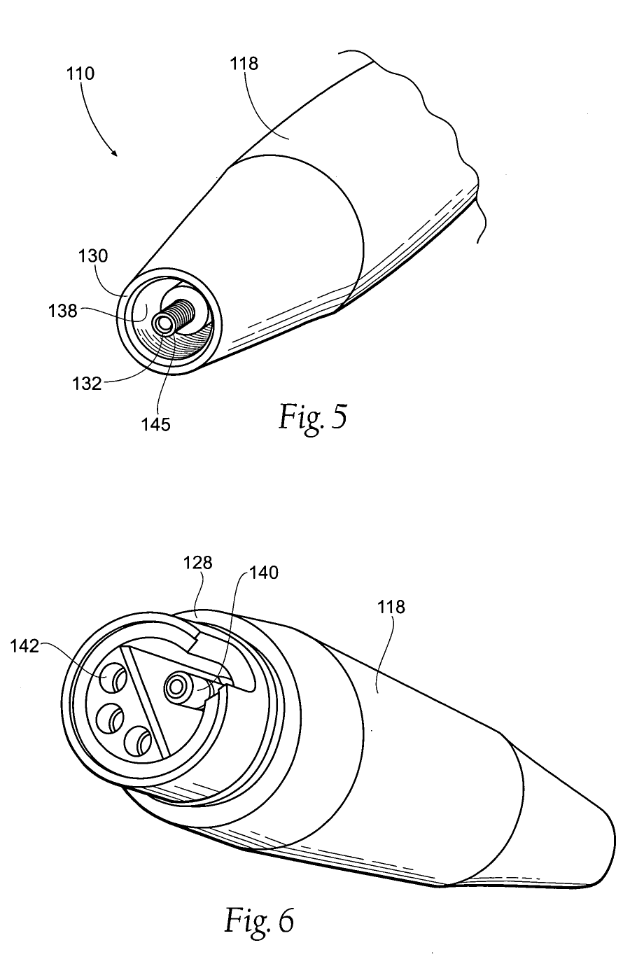

FIG. 5 shows a partial sectional view of the distal end 130 of the handpiece 118. The fluid outlet 132 is surrounded by a cavity 138. When the device 110 acts as a scaling device, the cavity 138 is desired to maintain the transfer of ultrasonic energy to the scaling tip 113 (not shown), while allowing the user to grip the handpiece closer to the tip 113. Without the cavity 138 surrounding the fluid outlet 132, the handpiece 118, which is preferably designed from a plastic material, would dampen the ultrasonic movement transferred from the ultrasonic vibration means to the outlet 132. As will be understood with regard to the remaining Figures, it is not required in the present invention that the adaptor 120 be connected to the handpiece 118 so that the cavity 138 is maintained. While the adaptor 120 may be configured so that the cavity 138 remains after the adaptor 120 is connected to the handpiece 118, it is not a necessity. The adaptor 120 could potentially be designed so that the adaptor has a dampening effect on the ultrasonic scaling means.

FIG. 6 shows a perspective view of the proximate end 128 of an exemplary handpiece 118. The proximate end 128 contains a mating area 140 for the fluid line 124 (FIG. 4) and a mating area 142 for the power lines 126 (FIG. 4). The mating areas 140 and 142 may be of any design, provided they form a secure fit for allowing fluid and power to flow through the handpiece 118. The arrangement, as shown, should not be considered limiting as to what types of handpieces 118 the present invention may be used in connection with the transfer of power and fluid. Also, the arrangement should not be considered as a limit on the design or configuration of the mating areas 140 and 142. FIG. 6 is shown to illustrate that the present invention allows an ultrasonic handpiece to act solely as an irrigation device, even if the handpiece 118 is connected to power means that would provide ultrasonic energy to the handpiece 118.

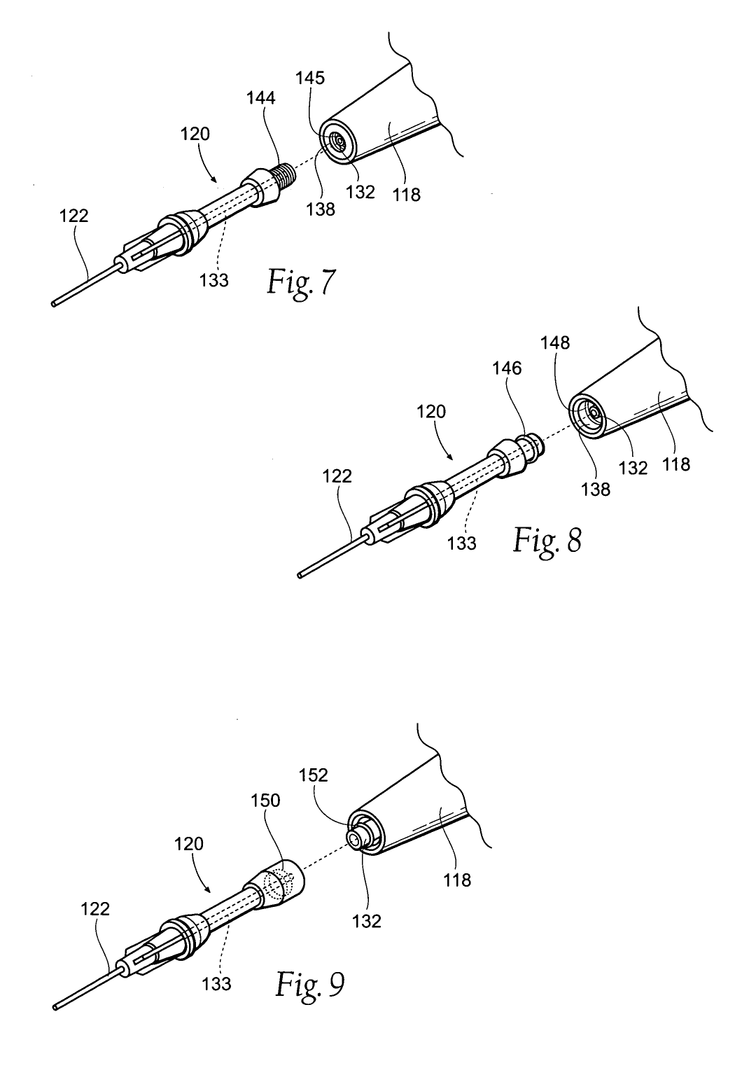

FIGS. 7-11 depict varying embodiments of the adaptor 120. FIG. 7 shows the adaptor 120 having an externally threaded area 144 that allows the adaptor to be screwed into internal mating threads 145 formed in the handpiece 118. The threaded area 144 may also be arranged so that it would be screwed onto the mating threads 145, even if the mating threads 145 were the same threads used for connecting an ultrasonic scaling tip (see FIG. 5). Since maintaining the cavity 138 after the adaptor 120 is attached to the handpiece is not a necessity, either arrangement will fall within the scope of the invention.

FIG. 8 presents the adaptor 120 having a gasket or an O-ring 146 that mates with a grooved area 148 located within the cavity 138 of the handpiece 118. The gasket 146 could be designed separately or integrally with the adaptor 120. For instance, the gasket 146 may consist of a raised area located on the adaptor 120 that nests within the grooved area 148. In such an arrangement, the adaptor 120 could be considered as having a press-fit type connection to the handpiece 118.

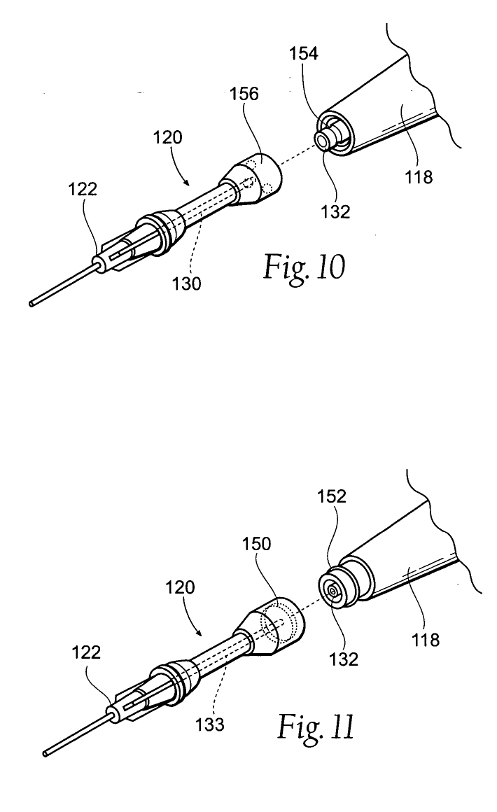

FIG. 9 provides an opposite arrangement to that of FIG. 8. A seal 152 located on the outer diameter of the outlet 132 mates with a groove 150 (shown in phantom) located within the inner diameter of the adaptor 120. FIG. 10 shows a further mating arrangement, where a channel 154 located around the outer diameter of the outlet 132 will receive spring-biased bearings 156. FIG. 11 shows yet another mating arrangement. The end of the adaptor 120 that mates with the handpiece 118 is larger than in previous designs. This allows for a spherical groove 150 formed within the adaptor end to mate with a seal 152 (shown in FIG. 9) on the outside of the handpiece 118, rather than within the cavity 132.

In all of the discussed designs, the adaptor 120 will connect to the handpiece 118 so that the outlet 132 is securely mated to the through bore 133 (shown in phantom) located within the adaptor 120, thereby providing a continuous and fluid-tight water pathway from the outlet 132 to the tip 122. Furthermore, the adaptor 120 is designed so that it will connect to the handpiece 118 in such a manner that extra sections or adaptors are not necessary. That is, the adaptor 120 will be manufactured according to the handpiece 118 and the manner that a scaling tip will be joined to the handpiece 118. The connecting means on the handpiece 118 and the adaptor 120 will not interfere with joining of a scaling tip to the handpiece 118, when necessary. It should be understood that if multiple adaptors or an adaptor having multiple sections were used, it would still fall within the scope of the invention, provided that the adaptor or adaptors would allow an irrigation tip to be used with an ultrasonic scaling device.

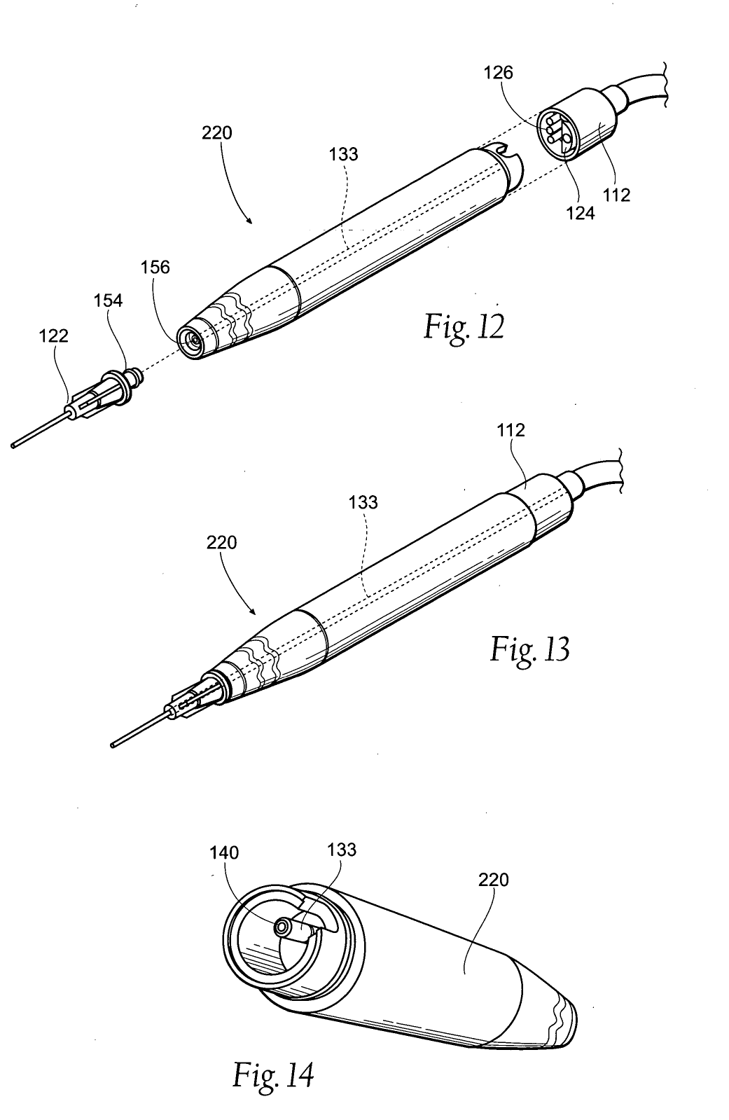

FIG. 12 depicts an exploded view of another embodiment of the present invention. A single adaptor 220 has replaced the handpiece 118 and the adaptor 120 previously discussed. The adaptor 220 connects directly to the supply line 112. The supply line 112 includes the fluid line 124 and the power lines 126 as previously described. The adaptor 220 restricts power from the power line 126 directly at the junction to the supply line 112, instead of restricting power after traversing the handpiece 118 as previously stated. The adaptor 220 is formed similar to the handpiece 118, in a manner that will allow the adaptor 220 to be easily grasped and held by the user. As in the previous embodiment, the tip 122 will be fittingly connected to the adaptor 220 in a fluid-tight arrangement. A LUER-LOK® connection arrangement is preferred. However, a male press fit 154 may be secured within the female receptacle 156, which allows the press fit 154 to fluidly connect the through bore 133 and the tip 122. The shown connection means could also be used in the previous arrangements and embodiments, as well.

FIG. 13 depicts a perspective view of the adaptor 220 shown in FIG. 12. As discussed, the adaptor 220 matingly connects to the supply line 112 and the irrigation tip 122. It also is perceived that the irrigation tip 122 and the adaptor 220 may be designed as a single integral attachment. Thus, a handpiece used with an ultrasonic scaling tip would be completely removed, and the adaptor 220 would be inserted in its place.

FIG. 14 shows a rear perspective view of the embodiment of the adaptor 220 and the mating end 140 of the through bore 133. However, there is no mating area for the power line 126 (see FIG. 12). Energy is not transferred to the adaptor 220 or the through bore 133, and the instrument will now only work as an irrigation device and not as an ultrasonic scaling device. The arrangement shown is merely exemplary of adaptors that may be used in place of a scaling handpiece 118 and be connected directly to the supply lines of the scaling device. As previously stated, an adaptor that allows fluid to flow from the ultrascaling device but restricts or interrupts power flow for scaling purposes will fall within the scope of the invention.

It should be understood that the above noted connection means are not inclusive of fluid coupling arrangements. The adaptors 120, 220 are not limited to manufacture from a conductive material, and is preferably made from a non-conductive autoclavable plastic material. The adaptor converts currently employed ultrasonic scaling instruments into irrigation devices without redesigning or permanently disabling the scaling instruments. The designed adaptors are also preferably of an autoclavable design, thereby contributing to an overall efficient, hygienic dental device.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

1. An adaptor for coupling a dental irrigation tip to an ultrasonic dental scaler handpiece, said dental scaler handpiece including ultrasonic vibration means, said dental handpiece being connectable to a power source for actuating said ultrasonic vibration means, said irrigation tip including a through bore, said dental handpiece including a conduit in fluid communication with a fluid source and in fluid communication with said adaptor, said adaptor comprising:
an elongated body having a distal end for connection to said irrigation tip and a proximal end for connection to said dental handpiece; and
a through bore located within said elongated body, said through bore in fluid communication with said conduit of said dental handpiece and said through bore of said irrigation tip.

2. The adaptor according to claim 1 further comprising means for restricting ultrasonic vibrations to said tip.

3. The adaptor according to claim 1 wherein said adaptor is plastic.

4. The adaptor according to claim 1 wherein said adaptor is autoclavable.

5. An adaptor for use with an ultrasonic dental handpiece and a dental irrigation tip, said adaptor converting said ultrasonic dental handpiece to a dental irrigation device, said adaptor comprising:
means for connecting said adaptor to said ultrasonic dental handpiece;
an elongated body having a through bore for fluid communication between said ultrasonic dental handpiece and said dental irrigation tip; and
means for connecting said adaptor to said dental irrigation tip.

6. An adaptor for use with an ultrasonic dental device and an irrigation tip having a through bore, said dental device connected to a power source and to a fluid reservoir, said dental device comprising supply lines releasably connected to an ultrasonic scaling handpiece including a fluid conduit and ultrasonic vibration means, said supply lines providing power to said ultrasonic vibration means and fluid to said conduit, said adaptor comprising:
an elongated body interchangeable with said handpiece, said elongated body having a distal end for connection to said supply lines of said dental device when said ultrasonic scaling device is removed from said scaling device, said elongated body having a through bore in fluid communication with said fluid supply lines; and
means for connecting said elongated body to said supply lines; and
means for connecting said elongated body at a proximal end to said irrigation tip, said through bore of said elongated body in fluid communication with said through bore of said irrigation tip.

7. The adaptor according to claim 6 wherein said irrigation tip is integrally formed with said elongated body.

8. The adaptor according to claim 6 wherein said connecting means further comprises means for restricting ultrasonic power to said adaptor.
